(19) United States
(12) Patent Application Publication
(10) Pub. No.: US 2026/0134673 A1
(43) Pub. Date: May 14, 2026

(54) SYSTEM AND METHOD FOR KNOWLEDGE DISTILLATION

(71) Applicant: Samsung Electronics Co., Ltd., Gyeonggi-do (KR)

(72) Inventors: Qingfeng LIU, San Diego, CA (US); Mostafa EL-KHAMY, San Diego, CA (US)

(21) Appl. No.: 19/390,079

(22) Filed: Nov. 14, 2025

Related U.S. Application Data
(60) Provisional application No. 63/720,658, filed on Nov. 14, 2024.

(51) Int. Cl. G06V 10/82; G06V 10/26; G06V 10/52; G06V 10/764; G06V 10/77

(52) U.S. Cl. CPC G06V 10/82; G06V 10/26; G06V 10/52; G06V 10/764; G06V 10/7715

(57) ABSTRACT

A system and a method are disclosed for KD. A method may include performing knowledge distillation (KD) from a vision transformer (ViT) teacher network to a convolutional neural network (CNN) student network.

### CROSS-REFERENCE TO RELATED APPLICATION

This application claims the priority benefit under 35 U.S.C. § 119 (e) of U.S. Provisional Application No. 63/720,658, filed on Nov. 14, 2024, the disclosure of which is incorporated by reference in its entirety as if fully set forth herein.

### TECHNICAL FIELD

The disclosure generally relates to knowledge distillation (KD) between heterogeneous network models. More particularly, the subject matter disclosed herein relates to improvements to KD from a vision transformer (ViT) model to a convolutional neural network (CNN) model.

### SUMMARY

Dense prediction methods, such as video panoptic segmentation (VPS), in which a model is used to make a prediction for each pixel in an input image, have become increasingly important in computer vision, unifying semantic segmentation and instance segmentation to provide both class-level and object-level understanding of video data. However, much of the research to date has centered on maximizing segmentation accuracy through the use of large-scale visual foundation models, sophisticated modules, and specialized loss functions.

While these approaches may have driven progress in benchmark performance, they tend to prioritize accuracy over computational efficiency, which may pose significant challenges for deployment in resource-constrained environments such as neural processing units (NPUs) of mobile devices.

To solve this problem, KD, which is a machine learning (ML) technique, may be used. For example, in KD, a large, pre-trained model (i.e., a teacher) may transfer its knowledge to a smaller, more efficient model (i.e., a student) in order to compress the large model for deployment on less powerful hardware by creating a smaller model that retains much of the teacher's performance. The process may involve training a student model (or network) to mimic the teacher's “soft” outputs, or detailed predictions, in addition to learning from the ground truth data.

One issue with the above approach is that KD frameworks normally apply KD to the same type of architecture, i.e., homogeneous network models, such as distilling a CNN teacher network to a CNN student network or distilling a ViT teacher network to a ViT student network.

Additionally, KD methods for heterogeneous network models mainly focus on logits without dealing with multiple scale features that may affect performance of a dense prediction method.

Further, most KD frameworks focus on logits or features for a classification problem, without consideration of dense prediction or object detection that may utilize multiple scale features and query-based transformer decoders.

To overcome these types of issues, systems and methods are described herein for a KD framework from ViT models, which may include ViT-adapter based KD (VA-KD) that may distill multiple scale features from ViT, embedding matching based KD (EM-KD) from a transformer decoder with non-ordered embeddings, and logits matching based KD (LM-KD) from a prediction head with non-ordered logits.

The above approaches improve on previous methods because they provide VA-KD method that may distill knowledge from a ViT teacher network to a CNN student network, provide an EM-KD method that may utilize matching between unordered teacher and student embeddings output from transformer decoders, and provide an LM-KD method that may utilize matching between unordered teacher and student mask and classification logits output from prediction heads. Additionally, these methods can help achieve state-of-the-art performance for tiny VPS models.

In an embodiment, a method comprises performing KD from a ViT teacher network to a CNN student network.

In an embodiment, a system comprises a processor; and a memory, communicatively coupled to the processor, storing instructions executable by the processor, individually or in any combination, to cause the processor to perform KD from a ViT teacher network to a CNN student network.

### BRIEF DESCRIPTION OF THE DRAWING

In the following section, the aspects of the subject matter disclosed herein will be described with reference to exemplary embodiments illustrated in the figures, in which:

FIG. 1 illustrates a system architecture of a KD framework, according to an embodiment;

FIG. 2 illustrates a system architecture of a teacher network, according to an embodiment;

FIG. 3 illustrates an example of a ViT and a ViT-Adapter, according to an embodiment;

FIG. 4 illustrates a system architecture of a student network, according to an embodiment;

FIG. 5 illustrates a system architecture utilizing a tiny VPS framework as a student network, according to an embodiment;

FIG. 6 illustrates an example of a tiny pixel decoder module, according to an embodiment;

FIG. 7 is a flowchart illustrating a method according to an embodiment of the disclosure;

FIG. 8 is a block diagram of an electronic device in a network environment, according to an embodiment.

FIG. 9 illustrates an example of a system performing KD, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “teacher network” refers to a large, complex model, such as a deep neural network (DNN), that has been trained to perform a task with high accuracy. A teaching network may act as an expert, providing “knowledge” that will be transferred. Generally, a teacher network is to be a source of learning, not to be deployed itself in a final application, e.g., due to its size and computational cost.

As used herein, the term “student network” refers to a smaller, more lightweight network designed to be more efficient for deployment. A student network may learn from the teacher network by trying to replicate its outputs or internal representations, which are richer than just the true labels. The student network (or model) can be a different architecture from the teacher, making it a versatile technique.

As used herein, the term “knowledge distillation” or “KD” refers to a model where a large, high-capacity “teacher” network transfers its knowledge to a smaller, more efficient “student” network. This technique may be used to create smaller models that are more practical for deployment, such as on mobile devices, while achieving similar performance to the larger teacher model. The student network may be trained to mimic the teacher's output, not just the ground truth labels, which allows it to learn more nuanced patterns from the teacher's “soft targets” or predictions.

As used herein, the term “logits” refers to raw, unnormalized output values from a final layer of a neural network, representing scores for each class before they are converted into probabilities. For example, logits can be any real number (positive or negative) and may be used as input for an activation function, like SoftMax or sigmoid, which then transforms them into interpretable probabilities.

As used herein, the term “video panoptic segmentation” or “VPS” refers to a computer vision task that extends image panoptic segmentation to video, providing a holistic understanding of all pixels in a video sequence by assigning both a semantic class (e.g., “road” or “sky”) and a unique instance identifier (ID) to each pixel. VPS may be used to assigns a semantic label and a unique instance ID to every pixel, distinguishing between countable “things” (e.g., cars, people, etc.) and uncountable “stuff” (e.g., sky, road, etc.). This may allow a system to differentiate between, for example, all individual cars (“car #1,” “car #2,” etc.) while simultaneously categorizing background regions like the road and sky. A goal of VPS is to simultaneously predict object classes, masks, instance IDs, and semantic segmentation for all pixels across time, which may be important for certain applications such as autonomous driving, virtual reality (VR), and augmented reality (AR).

While various embodiments of the present disclosure are described herein in relation to the performance of VPS, the embodiments are not limited thereto and may be similarly applied to other types of dense prediction methods, such as semantic segmentation, instance segmentation, depth estimation, etc.

While a ViT, in which the size and complexity of a transformer network is continually increasing, e.g., in the range of several billion parameters, has recently emerged as a leading approach in various domains, outperforming some other methods, a CNN may still be a preferred solution in resource-constrained environments such as NPUs of mobile devices. Therefore, it may be desirable to transfer the knowledge from ViT to a more compact and cost-effective CNN, e.g., using KD. However, due to substantial architectural disparities in representation and logits between these models, available KD methods have proven ineffective in this area.

As described above, available methods of distilling knowledge from ViT to CNN mainly focus on distilling knowledge directly from ViT to CNN. However, in a dense prediction regime like VPS, multiple scale features may be important for the final performance, which is not available in ViT explicitly.

Accordingly, an aspect of the present disclosure is to provide a novel framework for KD from ViT models.

According to an embodiment, a system and method of KD from a ViT are provided herein, which include VA-KD that distills multiple scale features from a ViT, EM-KD from a transformer decoder with non-ordered embeddings, and/or LM-KD from a prediction head with non-ordered logits.

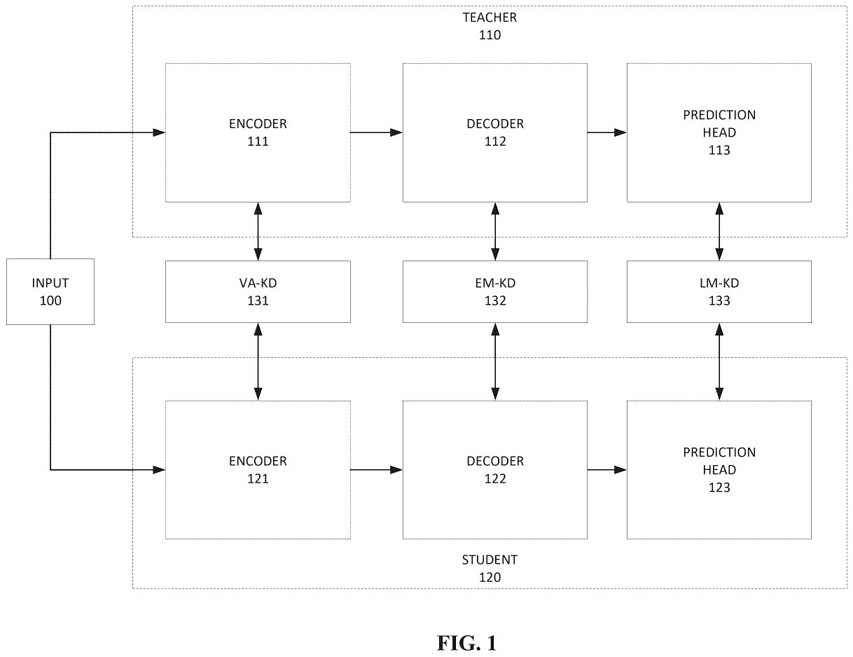

FIG. 1 illustrates a system architecture of a KD framework, according to an embodiment.

Referring to FIG. 1, the KD framework includes a teacher network 110, e.g., a ViT teacher network, and a student network 120, e.g., a CNN student network.

The teacher network 110 includes an encoder module 111 that may generate multiple scale features from received input 100, e.g., frames of a video, a decoder module 112 where query embeddings may be learned by transformer blocks, and a prediction head module 113 that may generate classification logits and mask logits. The prediction head module 113 may act as a specialized sub-network that interprets features and embeddings provided by the decoder module 112 and transforms them into the specific outputs for mask prediction and object classification. The architecture and specific layers used within the prediction head module 113 can vary depending on the overall model design.

Similarly, the student network 120 includes an encoder module 121, e.g., a multi-scale encoder, which may be a CNN backbone, a decoder module 122, e.g., a tiny decoder, that has less complexity than the decoder module 112 in the teacher network 110, and a prediction head module 123, which also may generate classification logits and mask logits from learned query embeddings from the decoder module 122.

According to an embodiment, for each of type of module included in the teacher network 110 and the student network 120, corresponding KD operations may be performed. More specifically, for the encoder module 111 and the encoder module 121, VA-KD 131 may be performed. For the decoder module 112 and the decoder module 122, EM-KD 132 may be performed, and for the prediction head module 113 and the prediction head module 123, LM-KD 133 may be performed. Each of the VA-KD 131, EM-KD 132, and LM-KD 133 will described below in more detail.

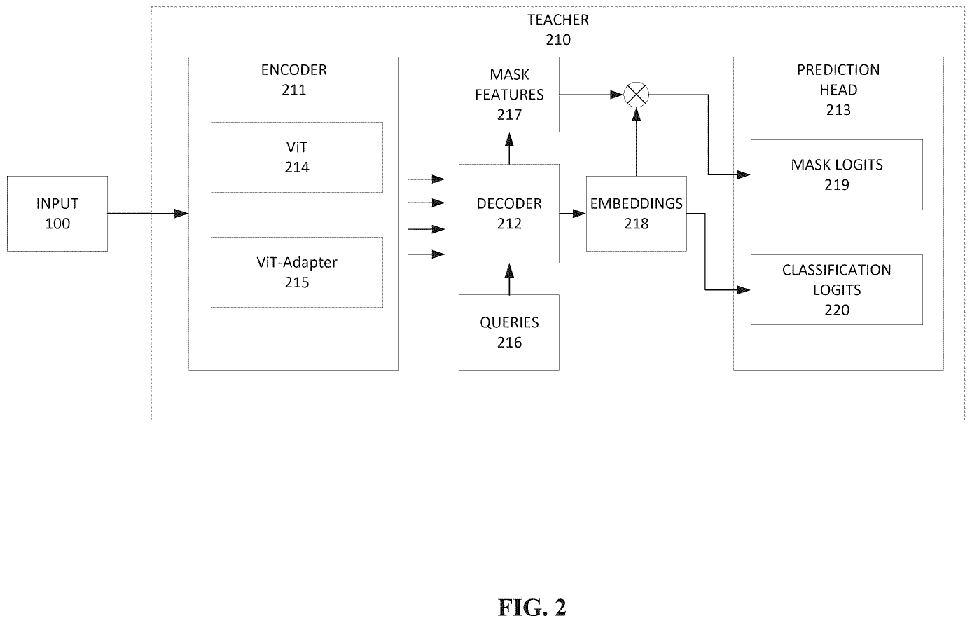

FIG. 2 illustrates a system architecture of a teacher network, according to an embodiment. For example, the teacher network 210 illustrated in FIG. 2 may be utilized as the teacher network 110 in FIG. 1.

Referring to FIG. 2, the teacher network 210 includes an encoder module 211 that may generate multiple scale features from received input 100, e.g., frames of a video, a decoder module 212 where query embeddings may be learned by transformer blocks, and a prediction head module 213 that may generate mask logits 219 and classification logits 220.

In the example of FIG. 2, the encoder module 211 includes a ViT 214 and a ViT-Adapter 215. The ViT 214 receives an image of the input 100 and may output a class prediction, which may be obtained by passing an output of a last transformer block through a classification head. The output of the ViT 214 may consist of a single fully connected layer.

According to an embodiment, the VIT-Adapter 215 may be applied to the VIT 214 in order to produce multiple scale features, e.g., of resolution ¼, ⅛, 1/16, and 1/32, of an image of the input 100. That is, the ViT-Adapter 215 may generate multiple scale features by cross interaction with the ViT 214. Because the ViT 214 does not provide multiple scale features, the ViT-Adapter 215 may be applied to output of the ViT 214 in order to produce multiple scale features that may be applied, e.g., to a multi-scale encoder, e.g., a CNN, in a student network, e.g., in VA-KD 131. For example, in VA-KD 131, a 1×1 convolution projector may be applied to match outputs from the student network and the ViT-Adapter 215 of the teacher network.

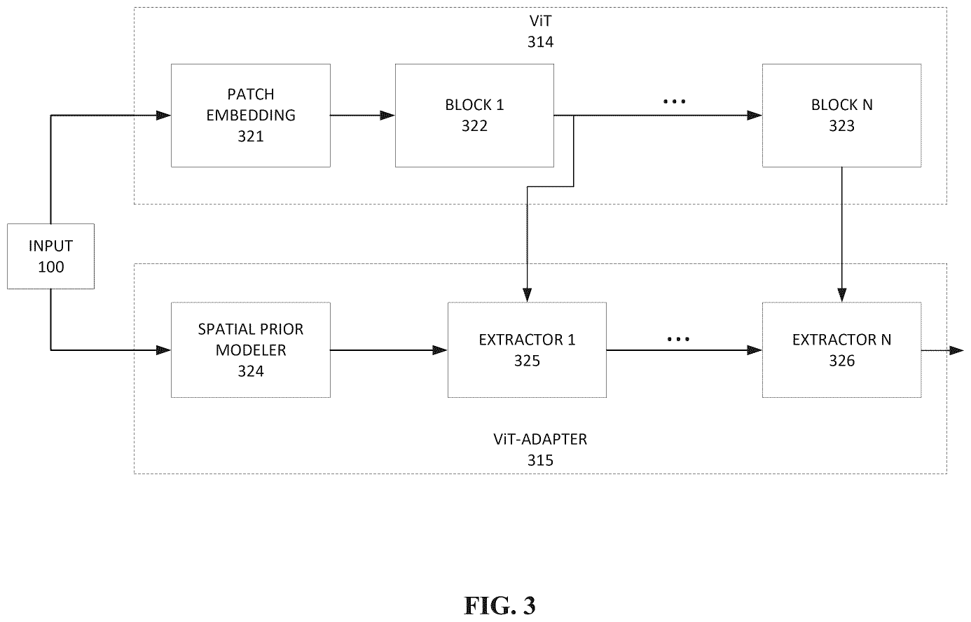

FIG. 3 illustrates an example of a ViT and a ViT-Adapter, according to an embodiment. For example, the ViT 314 and the ViT-Adapter 315 illustrated in FIG. 3 may be utilized as the ViT 214 and the ViT-Adapter 215 in FIG. 2, respectively.

Referring to FIG. 3, the ViT 314 includes a patch embedder 321 and m transformer blocks 322 to 323. The patch embedder 321 may divide an image of the input 100 into a grid of patches, flatten each patch into a vector, and then project these vectors into a lower-dimensional embedding space using a linear layer.

The transformer blocks 322 to 323 may be divided evenly into four stages by indices [[0, m/4-1], [m/4, m/2-1], [m/2, 3*m/4-1], [3*m/4, m]], where [si, sj] means that in stage s, block i will receive the input 100, and output of block j will interact with an extractor of the ViT-Adapter 315.

The ViT-Adapter 315, as an example, includes a spatial prior modeler 324 and a plurality of extractors 325 to 326. The spatial prior modeler 324 may include multiple convolution layers with downsampling, and may receive an image of the input 100 and output concatenated of flattened multiple scale features. More specifically, the spatial prior modeler 324 may provide a model with pre-existing knowledge about probable locations, arrangements, or relationships of objects and features within an image or spatial data. This prior knowledge may help guide the network to focus on relevant areas and can improve performance on tasks like segmentation, object recognition, and tracking.

The extractors 325 to 326 interact with the VIT 314 at chosen indices of the transformer blocks 322 to 323. Each of the extractors 325 to 326 receives two inputs, one from the spatial prior modeler 324 or a previous extractor, and the other from the output of a stage of the ViT 314. For example, the extractor 1 325 receives an input from the spatial prior modeler 324 and an input from the ViT 314 after block 1 322, while the extractor N 326 receives an input from a previous extractor (e.g., extractor N−1) and an input from the VIT 314 after block N 323.

The extractors 325 to 326 may combine and process features from both the spatial prior modeler 324 and the VIT 314. The extractors 325 to 326 may create high-quality, multi-scale features useful for dense prediction tasks, such as like segmentation, by injecting and extracting information at multiple stages of the VIT 314.

The final output of the last extractor N 323 may be split for each scale, e.g., ¼, ⅛, 1/16, and 1/32.

Referring again to FIG. 2, the decoder module 212 receives the multi-scale output from the encoder module 211. The decoder module 212 includes a plurality of transformer decoder blocks, e.g., one for each of feature map scales, e.g., ¼, ⅛, 1/16, and 1/32 resolutions.

The decoder module 212 may generate mask features 217 and embeddings 218 based on the received the multi-scale output from the encoder module 211 and queries 216.

The prediction head module 213 may then generate the mask logits 219 and the classification logits 220 from the mask features 217 and embeddings 218. For example, to generate the mask logits 219, the prediction head module 213 may pass the mask features 217 through a series of convolutional layers (e.g., in fully convolutional network (FCN)-style mask heads) or fully connected layers (e.g., in some transformer-based architectures). These layers may progressively refine the mask features 217 and project them into a lower-dimensional space corresponding to the desired mask resolution. The final layer of this sub-network may output a tensor of the mask logits 219. Each element in this tensor may represent the raw, unnormalized score for a pixel belonging to a specific object instance.

To generate the classification logits 220, the prediction head module 213 may feed the embeddings 218 into one or more fully connected (linear) layers. These layers learn to map the rich semantic information in the embeddings 218 to a set of scores for different object classes. The final layer outputs a vector of the classification logits 220. Each element in this vector may correspond to a raw, unnormalized score for the object belonging to a particular class.

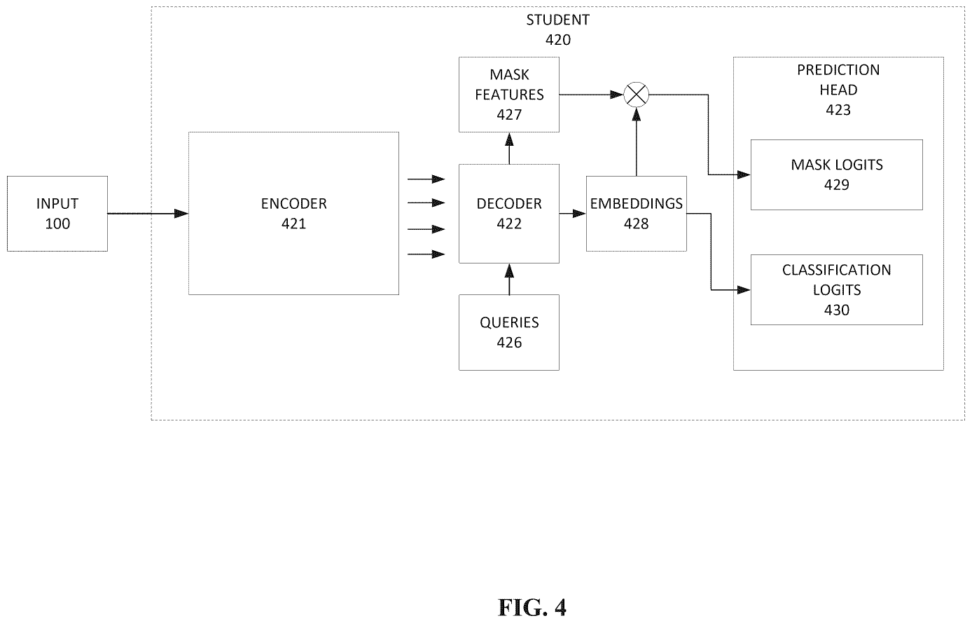

FIG. 4 illustrates a system architecture of a student network, according to an embodiment. For example, the student network 420 illustrated in FIG. 4 may be utilized as the student network 120 in FIG. 1.

Referring to FIG. 4, the student network 420 includes an encoder module 421 that may generate multiple scale features from received input 100, e.g., frames of a video, a decoder module 422 where query embeddings may be learned by transformer blocks, and a prediction head module 423 that may generate mask logits 429 and classification logits 430. While similar to the teacher network 210 of FIG. 2, the encoder module 421 of the student network 420 may be a multi-scale encoder, e.g., a CNN backbone, and the decoder module 422 has less complexity than a decoder module in a teacher network (e.g., the decoder module 212 of the teacher network 210).

The decoder module 422 receives the multi-scale output from the encoder module 421, and may generate mask features 427 and embeddings 428 based on the received the multi-scale output from the encoder module 421 and queries 426.

The prediction head module 423 may then generate the mask logits 429 and the classification logits 430 from the mask features 427 and embeddings 428.

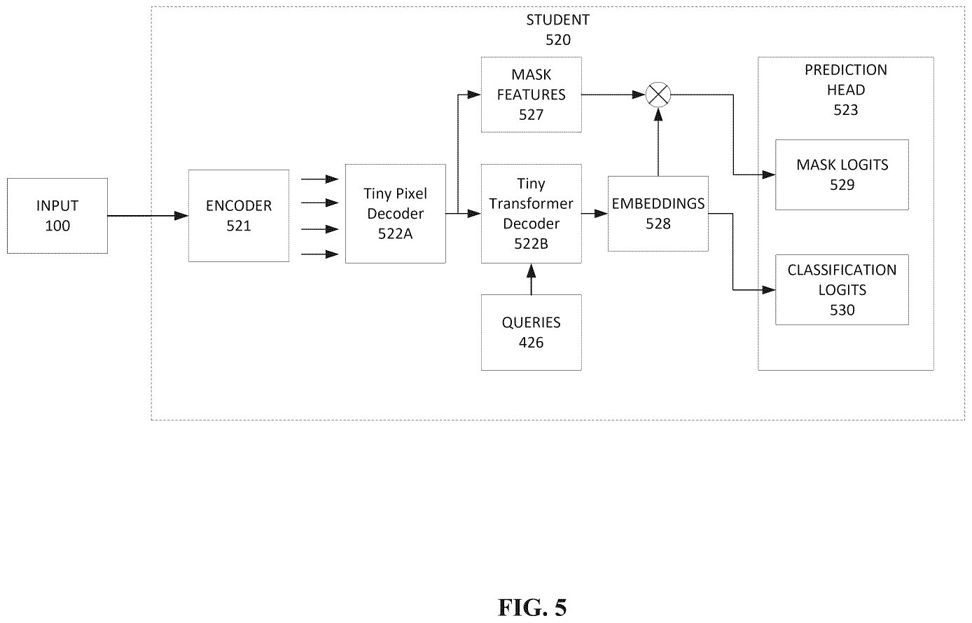

FIG. 5 illustrates a system architecture utilizing a tiny VPS framework as a student network, according to an embodiment. For example, the student network 520 illustrated in FIG. 5 may be utilized as the student network 120 in FIG. 1.

Referring to FIG. 5, the student network 520 includes an encoder module 521 that may generate multiple scale features from received input 100, e.g., frames of a video, a tiny pixel decoder module 522A, a tiny transformer decoder module 522B, and a prediction head module 523 that may generate mask logits 529 and classification logits 530. While similar to the student network 420 of FIG. 4, instead of including a single decoder module, e.g., the decoder module 422, a decoder module of the student network 520 may formed by the tiny pixel decoder module 522A and the tiny transformer decoder module 522B.

More specifically, consecutive frames of the input 100 may be first processed by the encoder module 521, which extracts multi-scale feature representations from each frame. These features are then passed the tiny pixel decoder module 522A, which produces a set of fused mask features 527 that may serve as the foundation for downstream segmentation.

The mask features 527 generated by the tiny pixel decoder module 522A are provided as input to the tiny transformer decoder module 522B, which incorporates queries 426 that interact with the multi-scale features to produce refined embeddings 528.

The embeddings 528 are used to generate mask logits 529 and classification logits 530. More specifically, the prediction head module 523 may generate the mask logits 529 from the mask features 527 and embeddings 528 and generate the classification logits 530 from the embeddings 528.

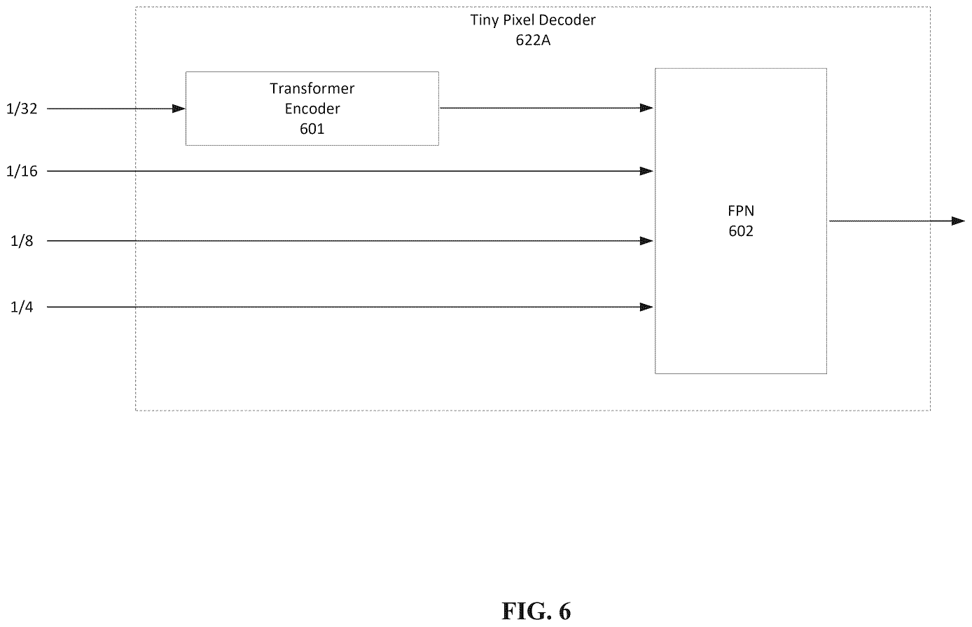

FIG. 6 illustrates an example of a tiny pixel decoder module, according to an embodiment. For example, the tiny pixel decoder module 622A illustrated in FIG. 6 may be utilized as the tiny pixel decoder module 522A in FIG. 5.

Referring to FIG. 6, a CNN backbone, e.g., the encoder module 521 of FIG. 5, may produce four feature maps at progressively reduced spatial resolutions of ¼, ⅛, 1/16, and 1/32 of the input image size. In some decoder designs, i.e., a non-tiny pixel decoder, all four scales are passed into multi-scale deformable attention modules to perform cross-scale interaction, which can be computationally demanding and not efficiently supported on mobile NPUs.

However, in the example of FIG. 6, only the coarsest feature map at 1/32 resolution is processed by a transformer encoder module 601, which enhances the semantic representation of the low-resolution features while maintaining computational efficiency. The enhanced 1/32 feature map, together with the 1/16 and ⅛ feature maps, is then combined through a feature pyramid network (FPN) 602. The FPN 602 merges information across scales and outputs refined feature maps at 1/32, 1/16, ⅛, and ¼ resolutions. The ¼ resolution feature map is designated as the mask feature output, which may be consumed by a subsequent tiny transformer decoder, e.g., the tiny transformer decoder module 522B.

By applying the transformer encoder module 601 only to the 1/32 scale, the tiny pixel decoder 622A avoids inefficiencies of deformable attention while retaining the ability to encode global semantic context. The subsequent FPN 602 fuses features across resolutions in a lightweight and hardware-friendly manner, generating multiple scale mask features for downstream processing. This design achieves comparable segmentation performance to other systems while significantly reducing complexity and improving deployability on mobile platforms.

Referring again to FIG. 1, the teacher network 110, e.g., a ViT teacher network such the teacher network 210 of FIG. 2, and the student network 120, e.g., a CNN student network such as the student network 420 in FIG. 4 or the student network 520 in FIG. 5, may perform KD operations, i.e., VA-KD 131, EM-KD 132, and/or LM-KD 133, to distill the knowledge of the more complex teacher network 110 to the student network 120.

To perform VA-KD 131, KD may be applied to the output of the encoder module 121 and the encoder module 111 of the student network 120 and the teacher network 110 respectively. More specifically, Equation (1) may be utilized to determine a loss function, e.g., based on the ViT-Adapter 215 ( [symbol] ), in order to minimize the squared difference between predicted and actual values.

$${ℒ}_{ViT A} = {\sum }_{i = 1}^{{n}_{E}} MSE ( {E}_{i}^{s} ( {x}_{i}^{s} ) , {E}_{i}^{t} ( {x}_{i}^{t} ) ) \qquad ( 1 )$$

In Equation (1),

$${E}_{i}^{t}$$

represents an i-th scale teacher feature transformation output from the ViT-Adapter 215, and

$${E}_{i}^{s}$$

represents a 1×1 projection of student feature transformation followed by batch normalization that is applied to the i-th scale feature from the encoder module 121 to match the dimension and scale. Additionally,

$${x}_{i}^{t}$$

represents teacher features of a computer vision model such as DINOv2-g,

$${x}_{i}^{s}$$

represents CNN Student features, and n_{g} represents the number of scales. The MSE(·) is the Mean Squared Error function.

To perform EM-KD 132, KD may be applied to the output embeddings from the decoder modules 112 and 122 after Hungarian Matching.

More specifically, eₛ∈q∈cₛ and eₜ∈q×cₜ may represent embeddings output by the decoder module 122 and the decoder module 112, respectively, where q is the number of queries or embeddings, and cₛ and cₜ are embedding feature sizes for the student network 120 and the teacher network 110, respectively.

Based on the foregoing, an embedding adapter as shown in Equation (2) may be applied to match the embedding feature sizes between for the student network 120 and the teacher network 110. For example, a Linear Layer and a Layer Norm layer may be applied.

$${e}_{s}^{{}_{′}} ∈ q \times {c}_{t} = adapter ( {e}_{s} ) \qquad ( 2 )$$

Next, an embedding matching (EM) method, e.g., a Hungarian Matching method, may be applied, as shown in Equation (3), to find a one-to-one correspondence between the student embeddings and teacher embeddings.

$$indices = EM ( {e}_{s}^{{}_{′}} , {e}_{t} ) \qquad ( 3 )$$

Thereafter, EM-KD 132 may be applied using an MSE loss for the matched student embeddings and teacher embeddings as shown in Equation (4).

$$EMKD = MSE ( {e}_{s}^{{}_{′}} [ indices ] , {e}_{t} ) \qquad ( 4 )$$

To perform LM-KD 133, KD may be applied to the output classification logits and mask logits from the prediction head modules 123 and 113 of both of the student network 120 and the teacher network 110 after matching, e.g., Hungarian Matching.

More specifically, lₛ∈q×c and lₜ∈q×c may represent the student classification logits and teacher classification logits respectively, where q is the number of queries or embeddings, and c is the number of classes. Similarly, Mₛ ∈q×h×w and Mₜ ∈q×h×w may represent the student mask logits and teacher mask logits respectively.

A total cost matrix Cₜₒₜₐₗ as shown in Equation (5) may be defined as a weighted sum of both a cost matrix of classification logits Cₗ and a cost matrix of mask logits C_{M}. Cₗ is the pairwise cost between lₛ and lₜ, e.g., a pairwise Kullback-Leibler (KL)-divergence between each instance in lₛ and each instance in lₜ. Similarly, C_{M} is the pairwise cost between Mₛ and Mₜ.

$${C}_{total} = α {C}_{l} + β {C}_{M} \qquad ( 5 )$$

Based on the foregoing, a logits matching (LM) method based on the total cost matrix Cₜₒₜₐₗ may be applied as shown in Equation (6) to find a one-to-one correspondence between the student logits and teacher logits.

$$indices = LM ( {C}_{total} ) \qquad ( 6 )$$

Thereafter, LM-KD 133 may be applied using the KL-divergence loss for the matched student classification logits and teacher classification logits, a Dice loss and a binary cross entropy (BCE) loss between the matched student mask logits and teacher mask logits as shown in Equation (7).

$$LMKD = {α}_{1} * KL ( {l}_{s} [ indices ] , {l}_{t} ) + {α}_{2} * DICE ( {M}_{s} [ indices ] , {M}_{t} ) + {α}_{3} * BCE ( {M}_{s} [ indices ] , {M}_{t} ) \qquad ( 7 )$$

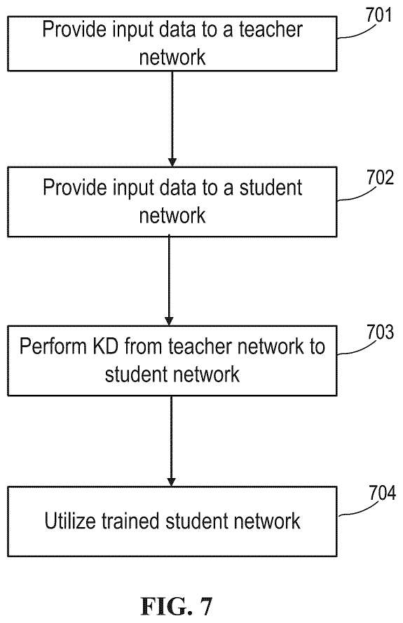

FIG. 7 is a flowchart illustrating a method according to an embodiment of the disclosure.

Referring to FIG. 7, in step 701, a teacher network including a first encoder module, a first decoder module, and a first prediction head module, e.g., the teacher network 110 including the encoder module 111, the decoder module 112, and the prediction head module 113 as illustrated in FIG. 1, receives input data, e.g., frames of a video.

In step 702, a student network may receive the input data. For example, as illustrated in FIG. 1, the student network 120 may include the encoder module 121, e.g., a multi-scale encoder, the decoder module 122, e.g., a tiny decoder, that has less complexity than the decoder module 112 in the teacher network 110, and the prediction head module 123.

In step 703, KD may be performed from the teacher network to the student network. For example, as illustrated in FIG. 1, for the encoder module 111 and the encoder module 121, VA-KD 131 may be performed. For the decoder module 112 and the decoder module 122, EM-KD 132 may be performed, and for the prediction head module 113 and the prediction head module 123, LM-KD 133 may be performed.

As described above, the KD in step 703 allows a large, high-capacity teacher network, e.g., a ViT teacher network, which has been trained to perform a task, such as VPS with high accuracy, to transfer its knowledge to a smaller, more efficient student network, e.g., a CNN student network, which may be utilized in a user equipment (UE), a smartphone, an IoT device, an edge computing system, autonomous vehicle, etc., and achieve similar performance as the teacher network.

Accordingly, in step 704, after KD, the student network may be utilized to perform a task such as VPS with similar performance as the teacher network. That is, the student network may be utilized to perform image panoptic segmentation to input video, by assigning both a semantic class (e.g., “road” or “sky”) and a unique instance ID to each pixel of the frames of the input video such that a same object instance has a same ID across consecutive frames of the video. As described above, VPS may be used to assigns a semantic label and a unique instance ID to every pixel, distinguishing between countable “things” (e.g., cars, people, etc.) and uncountable “stuff” (e.g., sky, road, etc.), which may allow a system to differentiate between elements include in the video frame.

For example, for autonomous driving, the student network may be utilized by vehicles to build a complete, real-time understanding of their surroundings, including distinguishing between individual cars, pedestrians, and road markings, to make safer and more informed decisions.

As another example, in robotics, the student network may be utilized by robots to better identify, understand, and interact with their environment, leading to more efficient object manipulation and navigation in complex workspaces.

As another example, in medical imaging, the student network may be utilized in medical devices to assist radiologists by precisely segmenting and identifying abnormal or healthy tissues in medical scans, which aids in more accurate diagnoses and treatment planning.

As another example, in AR/VR, the student network may be utilized to create more immersive and interactive AR/VR experiences by precisely segmenting real-world objects, allowing for more seamless integration of virtual elements with the physical environment.

As another example, in surveillance and security, the student network may be utilized by a security system to identify and track objects and people of interest in crowded scenes in real time, which can help in detecting unusual activities or unattended items.

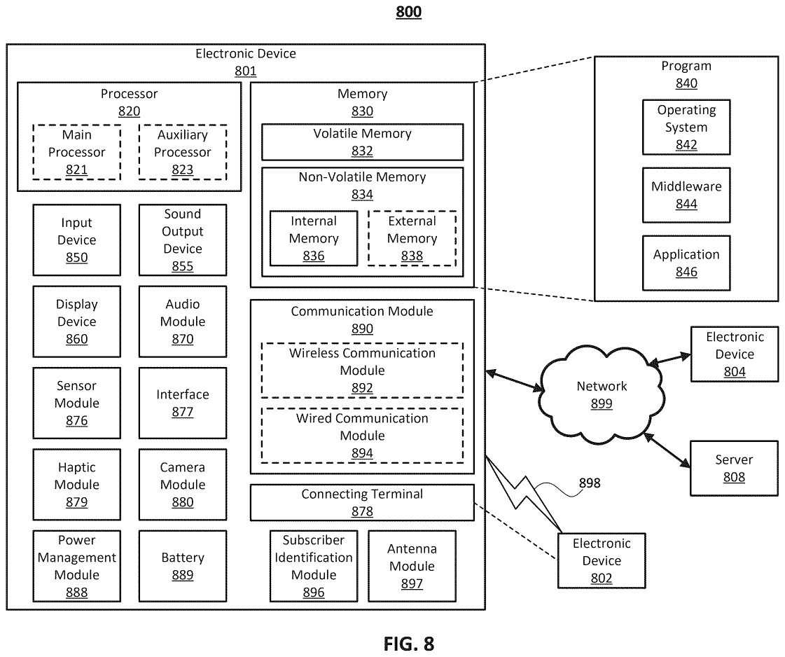

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU), an NPU, or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. For example, processor 820 may include an NPU that operates a student network, e.g., as illustrated in FIG. 1, 4, or 5.

Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

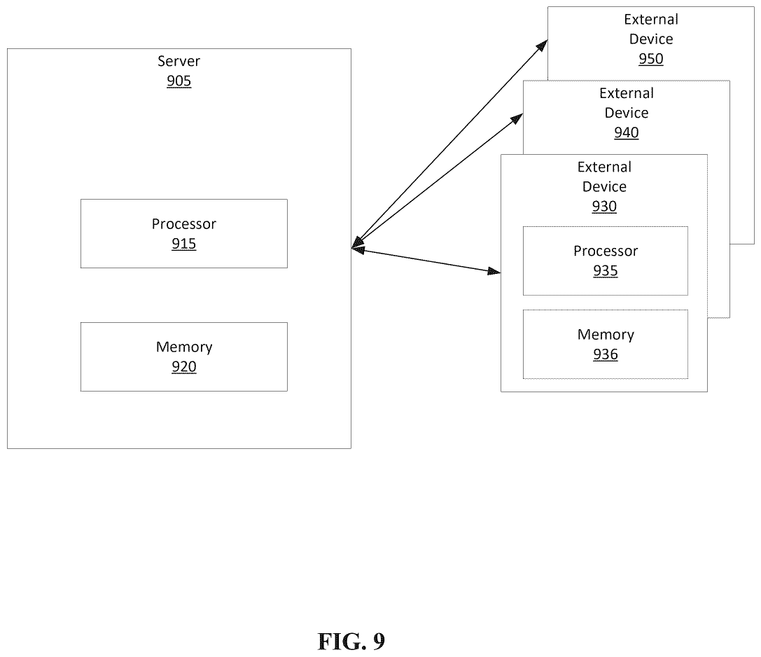

FIG. 9 illustrates an example of a system performing KD, according to an embodiment. For example, the system may be utilized to perform VPS or other dense prediction method.

Referring to FIG. 9 the system includes a server 905 and external devices 930, 940, and 950. For example, the external devices 930, 940, and 950 may include UEs, smartphones, IoT devices, edge computing systems, autonomous vehicles, etc. Additionally, although FIG. 9 illustrates three external devices by way of example, the present disclosure is not limited thereto, and the number of external devices may vary.

The server 905 includes a processor 915 and a memory 920. The processor 905 may be configured to train a teacher network and a student network using KD, e.g., as illustrated in FIGS. 1 through 6. The memory 920 may store the trained teacher and student network models.

The external device 930 includes a processor 935 and a memory 936. The processor 935 may also be configured to train a student network using KD from a teaching network in the server 905, e.g., as illustrated in FIGS. 1 through 6, and the memory 935 may store trained student network models.

According to an embodiment, the server 905, utilizing the processor 915, may train both a teacher network model and a student network model using KD, and then provide a trained student network model, e.g., over a wireless or wired network, to the external device 930, which stores the trained student network model in the memory 936, or the server 905, utilizing the processor 915, may train the teacher network model and provide the KD information, e.g., over a wireless or wired network, to the external device 930, which trains a student network model therein utilizing the processor 935 and the received KD information, and then may store the trained student network model in the memory 936.

Although not illustrated in FIG. 9, each of the external devices 940 and 950 may also include a processor and a memory, and may operate similarly to the external device 930.

In the example of FIG. 9, the server 905 may provide the teacher network, e.g. a relatively a large, complex model, e.g., a ViT teach network model, that has been trained to perform a task, such as VPS with high accuracy. Additionally, the teaching network of the server 905 may act as an expert, providing “knowledge” that can be transferred. That is, utilizing KD, the server 905 may be a source of learning for a smaller, more lightweight student network, which is designed to be more efficient for deployment in the external devices 930, 940, and 950. More specifically, KD, e.g., as illustrated in FIGS. 1 through 6, may be used to create smaller student network models, e.g., a CNN student network model, that are more practical for deployment in devices with less processing abilities or greater power consumption restrictions, such as on mobile devices, while achieving similar performance to the larger teacher model. The student network may be trained in the server 905 or in the external devices 930, 940, and 950 to mimic the teacher network's output, allowing it to learn more patterns from the teacher's predictions.

Accordingly, the server 905 and the external devices 930, 940, and 950 may utilize the teacher and student network models to perform VPS in order to assigns semantic labels and unique instance IDs to pixels in input video frames, distinguishing between countable “things” (e.g., cars, people, etc.) and uncountable “stuff” (e.g., sky, road, etc.), which may be used for various applications such as autonomous driving and AR.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A system, comprising:
a processor; and
a memory, communicatively coupled to the processor, storing instructions executable by the processor, individually or in any combination, to cause the processor to perform knowledge distillation (KD) from a vision transformer (ViT) teacher network to a convolutional neural network (CNN) student network.

2. The system of claim 1, wherein the ViT teacher network comprises:
a ViT; and
a ViT-Adapter configured to produce multiple scale features from output of the ViT.

3. The system of claim 2, wherein the ViT-Adapter comprises:
a spatial prior modeler; and
a plurality of extractors.

4. The system of claim 3, wherein the ViT comprises:
a patch embedder; and
a plurality of transformer blocks.

5. The system of claim 4, wherein each of the plurality of extractors is configured to produce multiple scale features from at least two of a first output of the spatial prior modeler, a second output of one of the plurality of transformer blocks, or a third output of a previous extractor among the plurality of extractors.

6. The system of claim 1, wherein the instructions further cause the processor to perform the KD from the ViT teacher network to the CNN student network by applying a Mean Squared Error (MSE) function to outputs from a first encoder of the ViT teacher network and a second encoder of the CNN student network.

7. The system of claim 1, wherein the instructions further cause the processor to perform the KD from the ViT teacher network to the CNN student network by:
applying an embedding adapter to match embedding feature sizes between for the CNN student network and the ViT teacher network,
performing embedding matching to find a one-to-one correspondence between CNN student network embeddings and ViT teacher network embeddings, and
applying a Mean Squared Error (MSE) function to matched CNN student network and ViT teacher network embeddings.

8. The system of claim 1, wherein the instructions further cause the processor to perform the KD from the ViT teacher network to the CNN student network based on outputs from a first prediction head of the ViT teacher network and a second prediction head of the CNN student network.

9. The system of claim 8, wherein the instructions further cause the processor to perform the KD from the ViT teacher network to the CNN student network based on the outputs from the first prediction head and the second prediction head by:
determining a total cost matrix based on a cost matrix of first classification logits of the ViT teacher network and second classification logits of the CNN student network, and a cost matrix of first mask logits of the ViT teacher network and second mask logits of the CNN student network,
performing logits matching based on the total cost matrix, and
performing logits matching KD based on the logits matching.

10. The system of claim 9, wherein the instructions further cause the processor to perform the logits matching KD by:
applying Kullback-Leibler (KL)-divergence loss for matched first classification logits and second classification logits, and
applying a Dice loss and a binary cross entropy (BCE) loss between matched first mask logits and second mask logits.

11. The system of claim 1, wherein the CNN student network comprises:
a tiny pixel decoder configured to generate mask features based on outputs from an encoder of the CNN student network; and
a tiny transformer encoder configured to generate embeddings based on the mask features generated by the tiny pixel decoder.

12. The system of claim 11, wherein tiny pixel decoder comprises:
a transformer encoder configured to enhance a coarsest feature map among a plurality of feature maps; and
a feature pyramid network (FPN) configured to generate multiple scale mask features from the enhanced feature map and the plurality of feature maps.

13. A method comprising:
performing knowledge distillation (KD) from a vision transformer (ViT) teacher network to a convolutional neural network (CNN) student network.

14. The method of claim 13, wherein the VIT teacher network includes:
a ViT that includes a patch embedder and a plurality of transformer blocks, and
a ViT-Adapter configured to produce multiple scale features from output of the ViT, wherein the ViT-Adapter includes a spatial prior modeler, and a plurality of extractors.

15. The method of claim 14, further comprising producing, by an extractor among the plurality of extractors, multiple scale features from at least two of a first output of the spatial prior modeler, a second output of one of the plurality of transformer blocks, or a third output of a previous extractor among the plurality of extractors.

16. The method of claim 13, wherein performing the KD from the VIT teacher network to the CNN student network comprises applying a Mean Squared Error (MSE) function to outputs from a first encoder of the ViT teacher network and a second encoder of the CNN student network.

17. The method of claim 13, wherein performing the KD from the ViT teacher network to the CNN student network comprises:
applying an embedding adapter to match embedding feature sizes between for the CNN student network and the ViT teacher network;
performing embedding matching to find a one-to-one correspondence between CNN student network embeddings and ViT teacher network embeddings; and
applying a Mean Squared Error (MSE) function to matched CNN student network and ViT teacher network embeddings.

18. The method of claim 13, wherein performing the KD from the VIT teacher network to the CNN student network is based on outputs from a first prediction head of the ViT teacher network and a second prediction head of the CNN student network.

19. The method of claim 18, wherein performing the KD from the VIT teacher network to the CNN student network based on the outputs from the first prediction head and the second prediction head comprises:
determining a total cost matrix based on a cost matrix of first classification logits of the ViT teacher network and second classification logits of the CNN student network, and a cost matrix of first mask logits of the ViT teacher network and second mask logits of the CNN student network;
performing logits matching based on the total cost matrix; and
performing logits matching KD based on the logits matching.

20. The method of claim 19, wherein performing the logits matching KD comprises:
applying Kullback-Leibler (KL)-divergence loss for matched first classification logits and second classification logits; and
applying a Dice loss and a binary cross entropy (BCE) loss between matched first mask logits and second mask logits.
